(19) United States
(12) Patent Application Publication
(10) Pub. No.: US 2005/0188855 A1
(43) Pub. Date: Sep. 1, 2005

(54) Coffee and water dispenser

(76) Inventor: Chang Kuei Tang, Banchiau City (TW)

Correspondence Address: Yi-Wen Tseng, 4331 Stevens Battle Lane, Fairfax, VA, 22033, US

(21) Appl. No.: 10/785,959

(22) Filed: Feb. 26, 2004

(51) Int. Cl. A47J 31/00

(52) U.S. Cl. 99/279

(57) ABSTRACT

A coffee and water dispenser, used to provide both drinking water and coffee is disclosed. The coffee and water dispenser has a water dispenser and a brewer attached to the water dispenser. The water dispenser has a main body that has a water dispensing region and a receiving space. The brewer is installed in the receiving space and connected to a hot water dispensing path of the water dispenser.

### BACKGROUND OF THE INVENTION The present invention relates in general to a coffee and water dispenser, and more particularly, to a dispenser operative to dispense cold and hot water and brew coffee.

During industrialization process, water pollution is always a problem that seriously affects the health of human beings. Therefore, in the modern society, cold and hot water processed by water fountain or dispenser has become the major source of drinking water in our daily lives.

Recently, coffee has become more and more popular in our daily lives. In the past, spirit lamps have been used to prepare freshly brewed coffee. As the spirit lamp brewing process is tedious and dangerous in operation, automatic electric coffee brewer has been developed to replace the tradition spirit lamp coffer brewer.

The water dispenser and coffee brewer are typically two individual appliances used for different purposes. Therefore, two individual spaces are required for equipping both of these appliances.

To resolve the problems caused by the conventional individual water dispenser and coffee brewer as described above, the Applicant, with many years of experience in this field, has developed a coffee and water dispenser as described as follows.

### BRIEF SUMMARY OF THE INVENTION

The present invention provides a machine that integrates the water dispenser and coffee brewer, such that the user can obtain cold water, hot water and brewed coffee from a single source. Therefore, the user does not need to feed water into the machine for brewing coffee.

The machine provided by the present invention includes a water dispenser and a brewer installed in the water dispensing region, such that grinds of coffee beans can be disposed in the brewer and brewed by the hot water of the water dispenser.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

These, as well as other features of the present invention, will become apparent upon reference to the drawings wherein:

FIG. 1 comprises a local exploded view of a coffee and water dispenser provided by the present invention;

FIG. 2 shows a perspective view of the coffer and water dispenser;

FIG. 3 shows the operation status of the coffee and water dispenser;

FIG. 4 shows a front view of the coffee and water dispenser;

FIG. 5 shows an internal structure of the coffee and water dispenser;

FIG. 6 shows the internal structure of a coffee and water dispenser in another embodiment of the present invention; and

FIG. 7 shows a perspective view of the coffee and water dispenser as shown in FIG. 6.

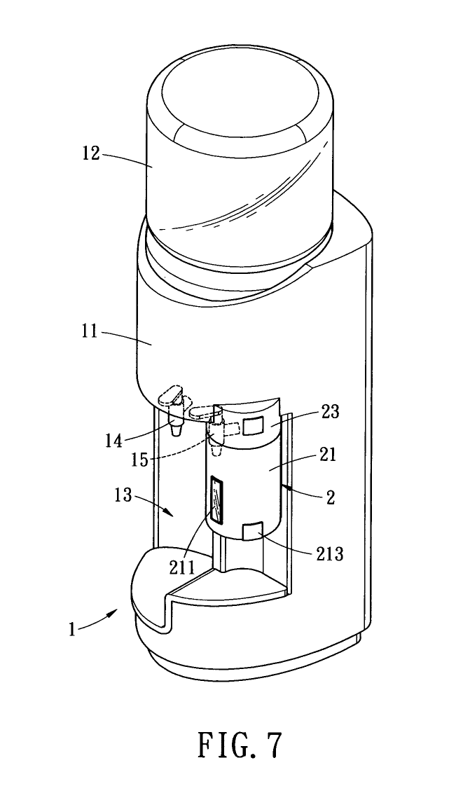

### DETAILED DESCRIPTION OF THE INVENTION

Reference will now be made in detail to the preferred embodiments of the present invention, examples of which are illustrated in the accompanying drawings. Wherever possible, the same reference numbers are used in the drawings and the description to refer to the same or like parts.

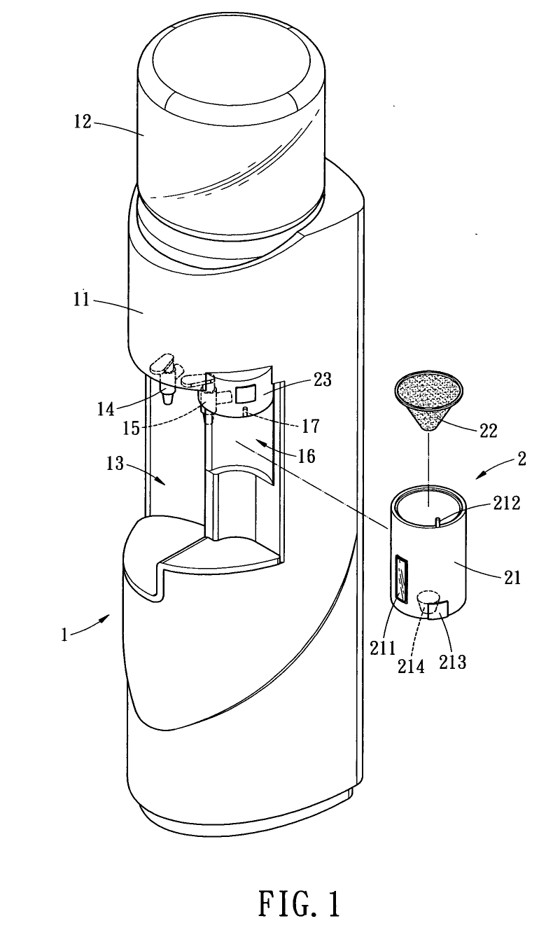

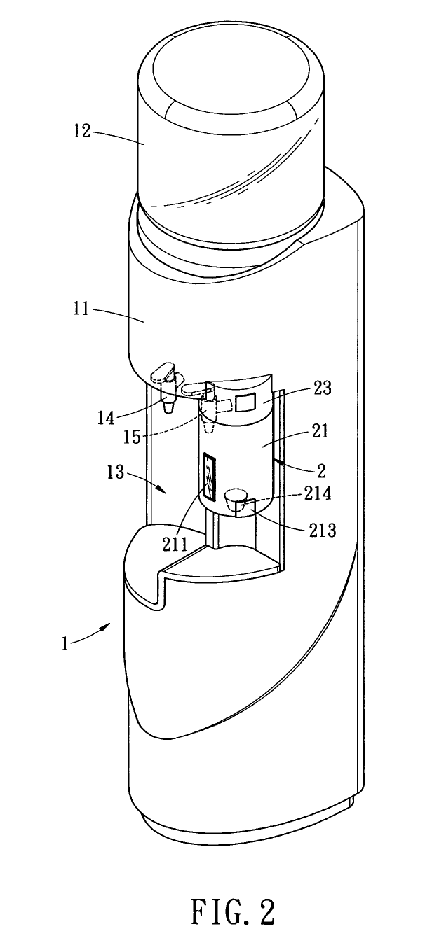

Referring now to the drawings wherein the showings are for purpose of illustrating preferred embodiments of the present invention only, and not for purposes of limiting the same. As shown in FIGS. 1 and 2, the present invention provides a coffee and water dispenser that includes a water dispenser 1 for providing cold and hot water and a brewer 2 for brewing coffee.

The water dispenser 1 includes a main body 11 and a water storage container 12 installed on the main body 11. The water storage container 12 is either fixed to the main body 11 or detachable from the main body 11. The main body 11 includes a water dispensing region 13, which comprises hot and cold water outlets such as water valves 14 and 15. The water dispensing region 13 further comprises a receiving space 16 and a control and connecting structure 23 for attaching a brewer 2 to the water dispenser 11.

The brewer 2 includes a container 21 and a filter 22. As shown, the container 21 preferably includes a window 211 allowing the user to observe the water or liquid level in the container 21. The container 21 further comprises a pivot 212 protruding from a top rim thereof, and the control and connecting structure 23 includes a pivot hole 17 for receiving the pivot 212 therein. Therefore, the container 21 can rotate horizontally about the pivot 212 and the pivot hole 17. The bottom of the container 21 includes an opening serving as a coffee outlet 214. The user can thus place a cup under the coffee outlet 214 in the receiving space 16 to receive coffee.

The filter 22 includes a mesh fabricated from metal, plastic, or paper to be disposed within the container 21. The grinds of coffee are added in the filter 22 to be brewed.

The control and connecting structure 23 is preferably so located over the water dispensing region 13, such that the hot water processed by the water dispenser 11 can flow into the container 22. The hot water supply of the coffee brewer 2 can be controlled manually or electronically. A control panel may be formed on the control and connecting structure 23.

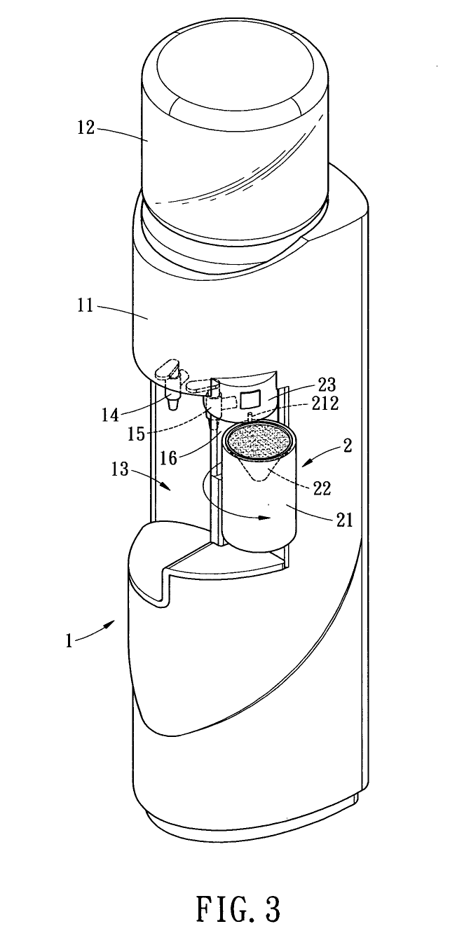

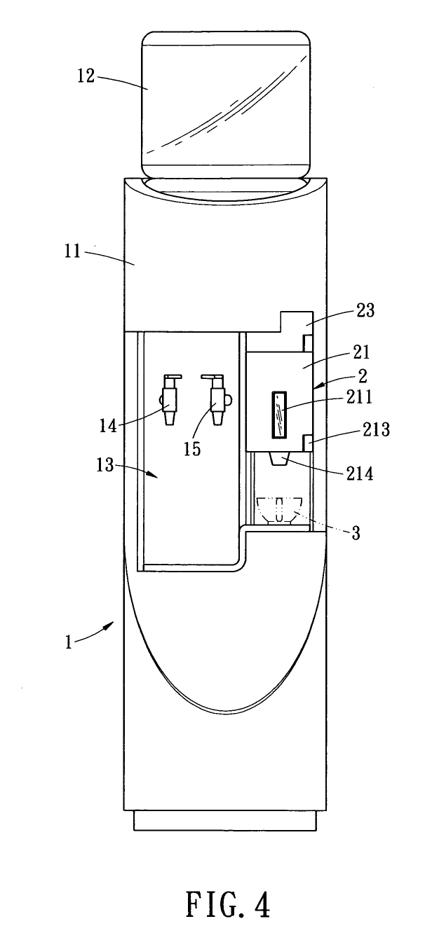

FIGS. 3 and 4 show the operation status and a front view of the coffee and water dispenser. As shown, by disposing a cup 3 under the cold water outlet 14 or hot water outlet 15, the cup 3 can be filled with cold or hot water by pressing the handle of cold or hot water outlet 14 or 15.

To fill the cup 3 with coffee, the push button 213 formed on the container 21 is pressed to open the container 21. Grinds of coffee can be added in the filter 21 of the container 22, and the container 21 is pushed back in the receiving space 16. The control and connecting structure 23 is then operated to manually or automatically control the hot water to flow into the container 22 through the filter 21. By disposing the cup 3 under the coffee outlet 214, the user can fill the cup 3 with coffee.

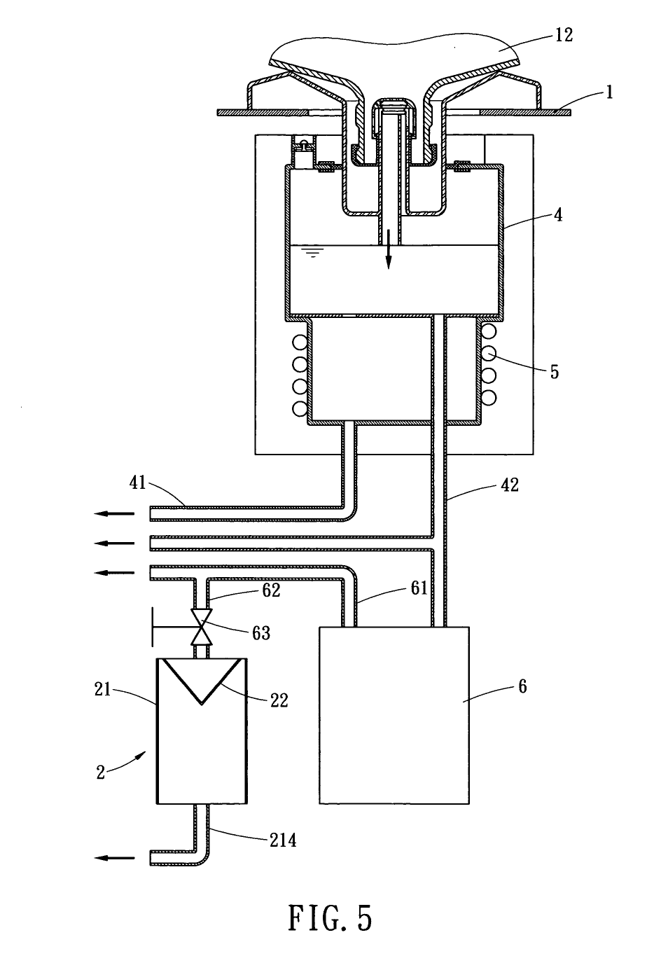

FIG. 5 illustrates the internal structure of the water dispenser 1. When the water storage container 12 is installed on the water dispenser 1, water in the container 12 is introduced into a cold water tank 4. Evaporators 5 are installed around the colder water tank 4 to produce ice water output to a conveying tube 41. Another conveying tube 42 is operative to convey cold water to a hot water tank 6. The water heated by the hot water tank 6 is then output to the hot water outlet 15 or the control and connecting structure 23 via water conveying tube 61 or 62 respectively. By setting up the control panel of the control and connecting structure 23, hot water can be injected through the water switch 63 to the brewer 2 for brewing coffee.

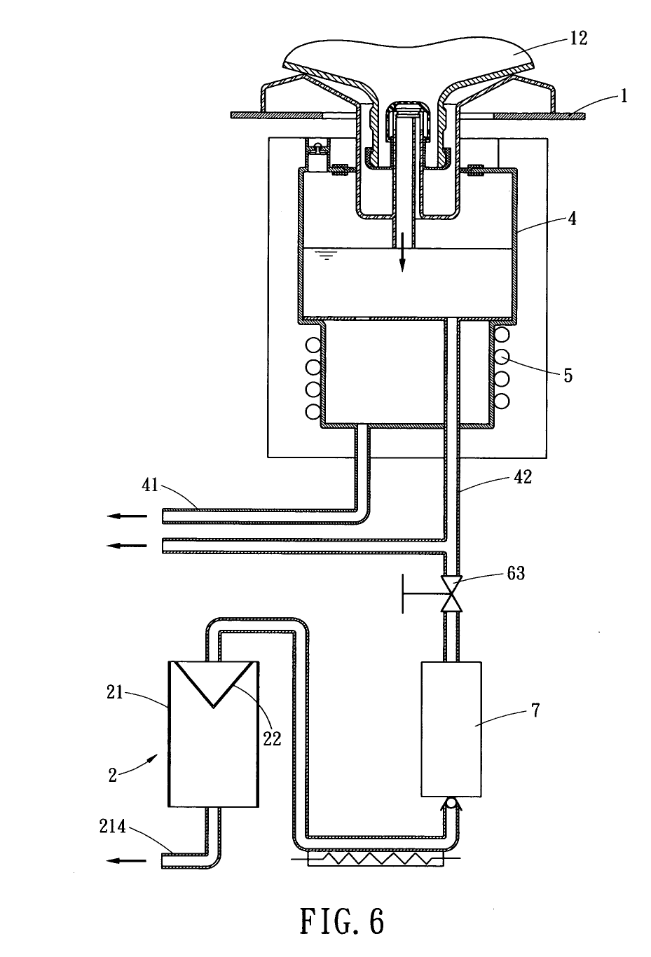

FIG. 6 shows the internal structure of another embodiment of the water dispenser 1. As shown, a small hot water tank 7 can be installed in the water dispenser 1. By connecting the water switch 63 to the conveying tube 42 and the small hot water tank 7 directly, the cold water in the colder water tank 4 can be directly input to the small hot water tank 7 to be processed before being injected into the brewer 2. Therefore, the hot water supply of the coffee brewer 2 is different from that for the hot water dispensing outlet 15.

The coffee and water dispenser can be applied to floor-top or counter-top water dispenser. Further, instead of making coffee, the coffee brewer 2 can also be used as a tea maker.

This disclosure provides exemplary embodiments of the present invnetion. The scope of this disclosure is not limited by these exemplary embodiments. Numerous variations, whether explicitly provided for by the specification or implied by the specification, such as variations in shape, structure, dimension, type of material or manufacturing process may be implemented by one of skill in the art in view of this disclosure.

1. A coffee and water dispenser, used to provide drinking water and coffee, the dispenser comprising:
a water dispenser, including a main body, which comprises a water dispensing region and a receiving space; and
a brewer attached to the water dispenser at the receiving space, wherein the brewer is connected to a hot water dispensing path of the water dispenser.

2. The dispenser of claim 1, wherein the brewer includes a coffee maker.

3. The dispenser of claim 1, wherein the brewer includes a tea maker.

4. The dispenser of claim 1, wherein the brewer is pivotally attached to the water dispenser.

5. The dispenser of claim 1, wherein the brewer includes a container, a filter disposed in the container and a control panel.

6. The dispenser of claim 5, wherein the container includes a window to observe liquid level therein.

7. The dispenser of claim 5, wherein the container includes a dispensing outlet.

8. The dispenser of claim 5, wherein the filter includes a mesh.

9. The dispenser of claim 8, wherein the mesh is fabricated from metal, plastic or paper.

10. The dispenser of claim 9, wherein the control panel includes a control button for manually controlling connection between the brewer and the hot water dispensing channel.

11. The dispenser of claim 9, wherein the control panel includes a control button for activating automatic control of the connection between the brewer and the hot water dispensing channel.

12. The dispenser of claim 1, wherein the main body further comprises a cold water outlet and a hot water outlet in the dispensing region.

13. The dispenser of claim 1, wherein the cold water outlet and hot water outlet include water valves.

14. The dispenser of claim 1, further comprising a hot water tank directly connected to the brewer.

15. The dispenser of claim 1, further comprising a hot water tank connected to the water dispensing region and the brewer through the water dispensing path.
